(19) United States
(12) Patent Application Publication
(10) Pub. No.: US 2025/0149044 A1
(43) Pub. Date: May 8, 2025

(54) ELECTRONIC DEVICE FOR UPDATING TARGET SPEAKER USING VOICE SIGNAL INCLUDED IN AUDIO SIGNAL AND TARGET SPEAKER UPDATING METHOD THEREFOR

(71) Applicant: SAMSUNG ELECTRONICS CO., LTD., Suwon-si (KR)

(72) Inventors: Jonguk YOO, Suwon-si (KR); Dokyun LEE, Suwon-si (KR); Jaeyoung ROH, Suwon-si (KR); Youngmoon JUNG, Suwon-si (KR); Changwoo HAN, Suwon-si (KR); Jungwook HWANG, Suwon-si (KR)

(21) Appl. No.: 19/013,349

(22) Filed: Jan. 8, 2025

Related U.S. Application Data
(63) Continuation of application No. PCT/KR2023/010206, filed on Jul. 17, 2023.

(30) Foreign Application Priority Data
Sep. 5, 2022 (KR) 10-2022-0112269

(51) Int. Cl. G10L 17/06

(52) U.S. Cl. CPC G10L 17/06

(57) ABSTRACT

An electronic device is provided. The electronic device includes: a voice reception unit comprising circuitry, memory storing an artificial intelligence model configured to acquire a voice signal of a user from an audio signal and information on characteristics of a plurality of users, and at least one processor, comprising processing circuitry, individually and/or collectively, configured to: based on an audio signal being received through the voice reception unit, obtain a first audio signal by inputting information on a characteristic of a first user set as a target speaker among the plurality of users and the received audio signal to the artificial intelligence model, based on voice recognition based on the first audio signal failing, identify a similarity between information on a characteristic of a second audio signal excluding the first audio signal among the received audio signals and information on characteristics of remaining users excluding the first user among the plurality of users, and change the target speaker to a second user among the plurality of users.

### CROSS-REFERENCE TO RELATED APPLICATIONS

This application is a continuation of International Application No. PCT/KR2023/010206 designating the United States, filed on Jul. 17, 2023, in the Korean Intellectual Property Receiving Office and claiming priority to Korean Patent Application No. 10-2022-0112269, filed on Sep. 5, 2022, in the Korean Intellectual Property Office, the disclosures of each of which are incorporated by reference herein in their entireties.

### BACKGROUND

### Field

The disclosure relates to an electronic device for updating a target speaker using a voice signal included in an audio signal, and a method for updating the target speaker.

### Description of Related Art

With the development of electronic technology, various types of electronic devices have been developed and popularized, and the electronic devices may provide various functions.

For example, an electronic device may receive a user voice and perform voice recognition regarding the user voice. In this case, the electronic device may obtain a voice signal including the user voice from the received audio signal, and perform voice recognition using the voice signal.

### SUMMARY

An electronic device according to an example embodiment includes: a voice reception unit comprising voice receiving circuitry, memory storing an artificial intelligence model configured to acquire a voice signal of a user from an audio signal and information on characteristics of a plurality of users, and at least one processor, comprising processing circuitry. At least one processor, individually and/or collectively, is configured to: based on an audio signal being received through the voice reception unit, obtain a first audio signal by inputting information on a characteristic of a first user set as a target speaker among the plurality of users and the received audio signal to the artificial intelligence model; based on voice recognition based on the first audio signal failing, identify a similarity between information on a characteristic of a second audio signal excluding the first audio signal among the received audio signals and information on characteristics of remaining users excluding the first user among the plurality of users; and change the target speaker to a second user among the plurality of users.

A method of updating a target speaker of an electronic device according to an example embodiment includes: based on an audio signal being received, acquiring a first audio signal by inputting information on a characteristic of a first user set as a target speaker among a plurality of users and the received audio signal to an artificial intelligence model configured to acquire a voice signal of a user from an audio signal, based on voice recognition based on the first audio signal failing, identifying a similarity between information on a characteristic of a second audio signal excluding the first audio signal among the received audio signals and information on characteristics of remaining users excluding the first user among the plurality of users, and changing the target speaker to a second user among the plurality of users.

In a non-transitory computer-readable medium storing computer instructions that, when executed by at least one processor of an electronic device, individually and/or collectively, cause the electronic device to: based on an audio signal being received, obtain a first audio signal by inputting information on a characteristic of a first user set as a target speaker among a plurality of users and the received audio signal to an artificial intelligence model configured to acquire a voice signal of a user from an audio signal, based on voice recognition based on the first audio signal failing, identify a similarity between information on a characteristic of a second audio signal excluding the first audio signal among the received audio signals and information on characteristics of remaining users excluding the first user among the plurality of users, and change the target speaker to a second user among the plurality of users.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example electronic device according to various embodiments;

FIG. 2 is a block diagram illustrating an example configuration of an electronic device according to various embodiments;

FIG. 3 is a diagram illustrating an example configuration of a dialog system according to various embodiments;

FIGS. 4, 5, 6, 7 and 8 are diagrams illustrating example methods of updating a speaker embedding vector that is input to an artificial intelligence model according to various embodiments;

FIG. 9 is a block diagram illustrating an example configuration of an electronic device according to various embodiments; and

FIG. 10 is a flowchart illustrating an example method of updating a target speaker of an electronic device according to various embodiments.

### DETAILED DESCRIPTION

The various example embodiments of the present disclosure may be modified in various ways, so specific embodiments are illustrated in the drawings and described in greater detail in the detailed description. However, it is to be understood that the disclosure is not limited to the various example embodiments, but includes all modifications, equivalents, and/or alternatives according to example embodiments of the disclosure. Throughout the description of the accompanying drawings, similar components may be denoted by similar reference numerals.

In describing the disclosure, when it is decided that a detailed description for the known functions or configurations related to the disclosure may unnecessarily obscure the gist of the disclosure, the detailed description therefor may be omitted.

In addition, the following example embodiments may be modified in several different forms, and the scope of the technical spirit of the disclosure is not limited to the following example embodiments.

Terms used in the disclosure are used simply to describe various example embodiments rather than limiting the scope of the disclosure. Singular forms are intended to include plural forms unless the context clearly indicates otherwise.

In the disclosure, the expressions “have”, “may have”, “include” or “may include” used herein indicate existence of corresponding features (e.g., elements such as numeric values, functions, operations, or components), but do not exclude presence of additional features.

In the disclosure, the expressions “A or B”, “at least one of A or/and B”, or “one or more of A or/and B”, and the like may include any and all combinations of one or more of the items listed together. For example, the term “A or B”, “at least one of A and B”, or “at least one of A or B” may refer to all of the case (1) where at least one A is included, the case (2) where at least one B is included, or the case (3) where both of at least one A and at least one B are included.

Expressions “first”, “second”, “Ist,” “2nd,” or the like, used in the disclosure may indicate various components regardless of sequence and/or importance of the components, may be used to distinguish one component from the other components, and do not limit the corresponding components.

When it is described that an element (e.g., a first element) is referred to as being “(operatively or communicatively) coupled with/to” or “connected to” another element (e.g., a second element), it should be understood that it may be directly coupled with/to or connected to the other element, or they may be coupled with/to or connected to each other through an intervening element (e.g., a third element).

On the other hand, when an element (e.g., a first element) is referred to as being “directly coupled with/to” or “directly connected to” another element (e.g., a second element), it should be understood that there is no intervening element (e.g., a third element) in-between.

An expression “˜configured (or set) to” used in the disclosure may be replaced by an expression, for example, “suitable for,” “having the capacity to,” “˜designed to,” “˜adapted to,” “˜made to,” or “˜capable of” depending on a situation. A term “˜configured (or set) to” may not necessarily refer to being “specifically designed to” in hardware.

Instead, an expression “˜an apparatus configured to” may refer, for example, to an apparatus that “is capable of” together with other apparatuses or components. For example, a “processor configured (or set) to perform A, B, and C” may refer, for example, to a dedicated processor (e.g., an embedded processor) for performing the corresponding operations or a generic-purpose processor (e.g., a central processing unit (CPU) or an application processor) that may perform the corresponding operations by executing one or more software programs stored in a memory device.

In various example embodiments, a ‘module’ or a ‘˜er’ may perform at least one function or operation, and be implemented as hardware or software or be implemented as a combination of hardware and software. In addition, a plurality of ‘modules’ or a plurality of ‘˜er’ may be integrated into at least one module and be implemented as at least one processor (not shown) except for a ‘module’ or a ‘˜er’ that needs to be implemented as specific hardware.

Various elements and regions in the drawings are schematically drawn in the drawings. Therefore, the technical concept of the disclosure is not limited by a relative size or spacing drawn in the accompanying drawings.

Hereinafter, various example embodiments according to the present disclosure will be described in greater detail with reference to the accompanying drawings.

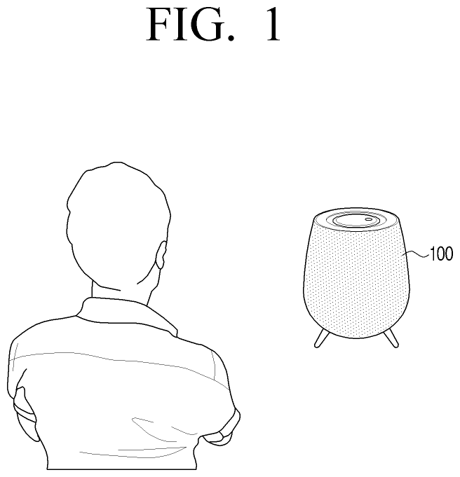

FIG. 1 is a diagram illustrating electronic device according to various embodiments.

Referring to FIG. 1, the electronic device 100 performs voice recognition. For example, the electronic device 100 may perform natural language understanding of a user voice and perform a function corresponding to the user voice based on a result of the natural language understanding. The natural language understanding may refer, for example, to determining the user's intent included in a natural language used in daily life. Accordingly, the electronic device 100 may provide an answer to the user's question or perform a function of the electronic device 100 according to the user voice.

Such an electronic device 100 may be implemented in a variety of forms, such as, for example, and without limitation, a TV, AI speaker, smartphone, tablet PC, desktop PC, wearable device, or the like.

The electronic device 100 may utilize an artificial intelligence model (or a neural network model or a learning network model) to separate a voice signal of a target speaker from an audio signal received by the electronic device 100 in order to improve the performance of voice recognition.

The target speaker may be at least one user pre-registered with the electronic device 100, who is set as a target for voice recognition.

The electronic device 100 may store information on a characteristic of the target speaker. When an audio signal is received, the electronic device 100 may input the received audio signal and the information on the characteristic of the target speaker to an artificial intelligence model to separate the target speaker's voice from the audio signal.

In this case, the electronic device 100 according to an embodiment may utilize voice signals included in the audio signal to select a target speaker. In other words, the electronic device 100 may utilize the voice signals included in the audio signal to identify which of a plurality of speakers registered with the electronic device 100 to set as the target speaker. For example, it is assumed that a first user is currently set as the target speaker, but the audio signal received by the electronic device 100 includes a voice signal from a second user who is not the first user. In this case, the electronic device 100 may change the target speaker from the first user to the second user using the voice signal included in the audio signal.

Accordingly, even when the electronic device 100 is a public device that can be used by a plurality of users, such as a TV, AI speaker, or the like, the user does not need to manually select a speaker to be subject to voice recognition, and voice recognition can be performed by effectively separating the voice of the speaker who is the subject of the speech from the received audio signal.

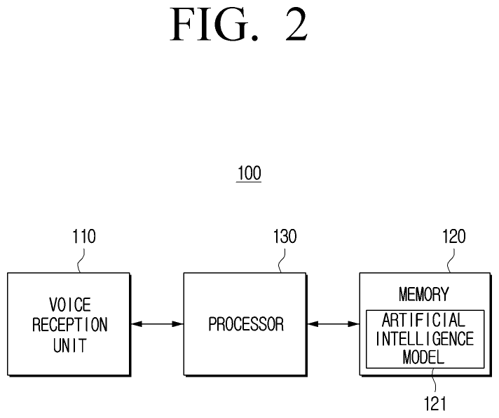

FIG. 2 is a block diagram illustrating an example configuration of an electronic device according to various embodiments.

Referring to FIG. 2, the electronic device 100 may include a voice reception unit (e.g., including voice receiving circuitry) 110, memory 120, and a processor (e.g., including processing circuitry) 130.

The voice reception unit 110 includes circuitry and is capable of receiving audio signals.

The voice reception unit 110 may include a microphone. Further, the voice reception unit 110 may communicate with an external electronic device that includes a microphone, and may receive audio signals received by the external electronic device from the external electronic device. To this end, the voice reception unit 110 may include a communication module for performing communication using methods such as Bluetooth, Wi-Fi, and the like.

The memory 120 may store instructions or programs associated with at least one component of the electronic device 100. Memory 120 may be implemented as non-volatile memory, volatile memory, flash-memory, hard disk drive (HDD), or solid state drive (SSD). The memory 120 may be accessed by the processor 130, and the data may be read/written/modified/deleted/updated by the processor 130. The term ‘memory’ used herein may include the memory 120, a ROM (not shown) within the processor 130, RAM (not shown), or a memory card (not shown) (e.g., micro SD card, memory stick) mounted in the electronic device 100.

The memory 120 may store characteristic information for a plurality of users. The characteristic information (or information on a characteristic) may include a speaker embedding vector (or speaker vector) for a user voice. The speaker embedding vector is a vector representing voice characteristics that can distinguish a speaker's tone, etc., as a list of numbers, and can include a d-vector. The d-vector represents a characteristic of a speaker, and may be obtained from a specific hidden layer of a trained speaker classification network.

The memory 120 may store an artificial intelligence model 121. The artificial intelligence model 121 may be a model for separating a user's (or speaker's) voice signal from an audio signal. The artificial intelligence model 121 may be a model trained to perform a VoiceFilter function. For example, the artificial intelligence model 121 may use the user's characteristic information to generate a mask for separating the user's voice signal from the audio signal. In other words, the artificial intelligence model 121 may receive an input of an audio signal and a speaker embedding vector of the user, and output a mask for separating the user's voice signal from the audio signal. In this case, as an example, the mask may be a value between 0 and 1. Accordingly, by applying the mask to the audio signal (for example, converting the audio signal into a frequency domain through Fourier transform, multiplying the audio signal converted into the frequency domain by the mask value, and then converting it back into a time domain through inverse Fourier transform), the user's voice signal can be separated from the audio signal. This artificial intelligence model may refer, for example, to a target mask prediction model including a Convolutional Neural Network (CNN), a Deep Neural Network (DNN), etc.

The processor 130 may be electrically coupled to the voice reception unit 110 and the memory 120 and include various processing circuitry to control the overall operations and functions of the electronic device 100. The processor 130 may control the overall operation of the electronic device 100 using various instructions or programs stored in the memory 120. For example, according to an embodiment, a main CPU may copy a program to RAM in accordance with instructions stored in ROM, and access the RAM to execute the corresponding program. Here, the program may include an artificial intelligence model or the like. The processor 130 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

For example, when an audio signal is received through the voice reception unit 110, the processor 130 may obtain a voice signal of a user who is set as the target speaker from the audio signal using the artificial intelligence model 121.

The target speaker may refer, for example, to a user being preset as a subject to voice recognition among a plurality of users registered with the electronic device 100.

For example, the memory 120 may store characteristic information of a plurality of users. In this case, the processor 130 may obtain the characteristic information of the user set as the target speaker from the characteristic information of the plurality of users. When an audio signal is received through the voice reception unit 110, the processor 130 may input the audio signal and the obtained characteristic information to the artificial intelligence model 121 to obtain a mask from the artificial intelligence model 121. The processor 130 may then apply the mask to the audio signal.

In this case, the mask may be a mask for separating the voice signal having the characteristic information input to the artificial intelligence model 121 (e.g., the characteristic information of the target speaker) from the audio signal. In other words, the mask may separate the voice signal having the characteristic information of the target speaker from the audio signal, and may attenuate other audio signals included in the audio signal. Accordingly, when the audio signal includes a voice signal of the target speaker, the processor 130 may apply the mask to the audio signal to obtain the voice signal of the target speaker from the audio signal. In this case, the processor 130 may obtain an amplified voice signal of the target speaker from the audio signal. However, when the audio signal does not include the target speaker's voice signal, there is no voice signal to be separated from the audio signal using the mask. Therefore, when the mask is applied to the audio signal, an attenuated signal may be obtained.

The processor 130 may perform voice recognition on the obtained user voice.

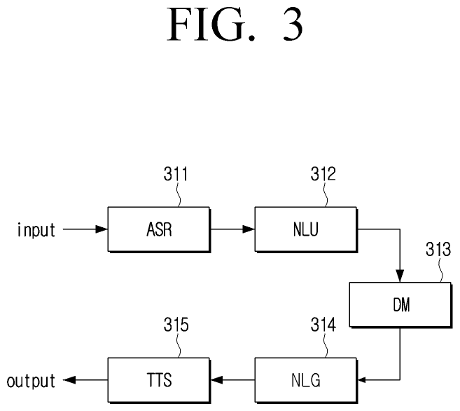

The memory 120 may store a dialog system for providing a response to a user voice. The dialog system may include an Automatic Voice recognition (ASR) module (311), a Natural Language Understanding (NLU) module (312), a Dialogue Manager (DM) module (313), a Natural Language Generator (NLG) module (314), and a Text-to-Speech (TTS) module (315), as shown, for example, in FIG. 3. Each of these modules may include various executable program instructions.

The voice recognition module 311 may convert a user voice in the form of audio data into text data. In this case, the automatic voice recognition module 311 may include an acoustic model and a language model. The acoustic model may include information related to vocalization, and the language model may include information about unit phoneme information and combinations of unit phoneme information. The voice recognition module 311 may convert a user voice into text data using the information about the vocalization and the information about the unit phoneme information. The information about the acoustic model and the language model may be stored, for example, in an automatic voice recognition database (ASR DB). In this case, the voice recognition module 311 may be named a speech-to-text (STT) module.

The natural language understanding (NLU) module 312 may perform a syntactic analysis or a semantic analysis based on the text data about the user voice obtained through voice recognition to determine the domain and user intent for the user voice. In this case, the syntactic analysis may divide a user input into grammatical units (e.g., words, phrases, morphemes, etc.), and determine what grammatical elements the divided units have. The semantic analysis may be performed using semantic matching, rule matching, formula matching, etc.

In this case, the natural language understanding module 312 may obtain a natural language understanding result, a category of the user voice, an intent of the user voice, and a slot (or, entity, parameter, etc.) for performing the intent of the user voice.

The dialog manager module 313 may obtain response information for the user voice based on the user intent and slot obtained by the natural language understanding module 312. In this case, the dialog manager module 313 may provide a response to the user voice based on knowledge DB. In this case, the knowledge DB may include private knowledge DB including personal information (e.g., application usage information, search history information, user's personal information, terminal device information, etc.) and public knowledge DB including general information other than personal information. The private knowledge DB may be included within the electronic device 100, but this is only an example embodiment, and may be stored on an external server (e.g., a cloud server, etc.) associated with the electronic device 100. The public knowledge DB may be stored on a separate external server.

Further, the dialog manager module 313 may determine whether the user intent as identified by the natural language understanding module 312 is clear. For example, the dialog manager module 313 may determine whether the user intent is clear based on whether there is insufficient information about the slot. In addition, the dialog manager module 313 may determine whether the slot identified by the natural language understanding module 312 is sufficient to accomplish a task. According to an embodiment, the dialog manager module 313 may perform feedback requesting the user for necessary information when the user's intent is not clear.

The natural language generation module 314 may change the response information or specified information obtained through the dialog manager module 313 into a text form. The textualized information may be in the form of a natural language utterance. The specified information may be, for example, information about additional input, information guiding the completion of an operation corresponding to a user input, or information guiding the user's additional input (e.g., feedback information about a user input). The information changed into a text form may be displayed on the display of the electronic device 100 or changed into a voice form by the TTS module 315.

In this case, the natural language generation module 314 may include a trained natural language generation model or a natural language template. The natural language generation module 314 may generate a response to the user voice in the form of natural language using the natural language generation model (or natural language template).

The TTS module 315 may change information in a text form into information in a voice (e.g., speech) form. In this case, the TTS module 315 may include a plurality of TTS models for generating a response in different voices, and the TTS models may be utilized to obtain a response in the voice form.

In this case, the voice recognition module 311, the natural language understanding module 312, the dialog manager module 313, the natural language generation module 314, and the TTS module 315 may be included within the electronic device 100. The voice recognition module 311, the natural language understanding module 312, the dialog manager module 313, the natural language generation module 314, and the TTS module 315 may be implemented as a combination of hardware (e.g., a system on chip (SoC), etc.) and software. For example, the voice recognition module 311, the natural language understanding module 312, the dialog manager module 313, the natural language generation module 314, and the TTS module 315 may be executed by a plurality of processors (e.g., CPU, NPU, GPU, etc.) within the SoC, but this is merely an example embodiment, and they may be executed by a plurality of cores within at least one processor.

For example, when the system on chip (SoC) included in the electronic device 100 includes a plurality of processors, the electronic device 100 may perform operations related to artificial intelligence (e.g., voice recognition, natural language understanding, etc.) among operations related to voice recognition using a graphics-only processor (e.g., a GPU (Graphic Processing Unit), a VPU (Vision processing unit), etc.) or an artificial intelligence-only processor (e.g., an NPU (Neural Processing Unit), a TPU (Tensor Processing Unit), etc.) among the plurality of processors, and may perform general operations (e.g., providing a response, etc.) excluding operations related to artificial intelligence among operations related to voice recognition using a general-purpose processor (e.g., a CPU (Central Processing Unit), an AP (Application Processor) among the plurality of processors.

In the above-described example, it is described that the voice recognition module 311, the natural language understanding module 312, the dialog manager module 313, the natural language generation module 314, and the TTS module 315 are included within the electronic device 100, but this is simply an example, and they may be distributed across at least one server. For example, the voice recognition module 311 may be included in a first server (e.g., a voice recognition server), the natural language understanding module 312 may be included in a second server (e.g., a natural language understanding server), the dialog manager module 313 may be included in a third server (e.g., a dialog manager server), the natural language understanding module 314 may be included in a fourth server (e.g., a natural language generation server), and the TTS module 315 may be included in a fifth server (e.g., a TTS server). In this case, the first server to the fifth server may be directly connected to each other or connected through the electronic device 100 (or an intermediary server) to send and receive data for recognizing a voice and providing a response.

Accordingly, the processor 130 may provide a response to the user voice using the dialog system. In other words, when the processor 130 obtains the target speaker's voice from the audio signal using the artificial intelligence model 121, the processor 130 may perform voice recognition on the target speaker's voice and provide a response to the voice according to the voice recognition. However, when the processor 130 obtains noise from the audio signal using the artificial intelligence model 121, the processor 130 cannot perform the voice recognition normally. In other words, the voice recognition may fail.

Since the characteristic information of the user set as the target speaker is input to the artificial intelligence model 121, when a user other than the user currently set as the target speaker speaks, the voice signal may not be separated from the received audio signal and an attenuated signal may be obtained. Accordingly, the voice recognition fails.

In this case, according to an embodiment of the present disclosure, the processor 130 may change the target speaker to another user based on the received audio signal, and separate the voice signal of corresponding user from the received audio signal. In other words, the processor 130 may identify characteristic information to be input to the artificial intelligence model 121 among the characteristic information of the plurality of users stored in the memory 120 based on the received audio signal, and separate the voice signal from the audio signal using the identified characteristic information.

For example, when an audio signal is received through the voice reception unit 110, the processor 130 obtains a first audio signal by inputting information on a characteristic of a first user of the plurality of users who is set as the target speaker and the received audio signal to the artificial intelligence model 121.

In other words, when an audio signal is received through the voice reception unit 110, the processor 130 may input information on a characteristic of the target speaker among the plurality of users, e.g., the user currently set as the target for voice recognition and the received audio signal to the artificial intelligence model 121 to obtain a mask from the artificial intelligence model 121.

In this case, since the characteristic information of the target speaker is input to the artificial intelligence model 121, the mask output from the artificial intelligence model 121 may be a mask for separating the target speaker's voice from the audio signal.

Accordingly, when the audio signal includes the voice of the first user who is the target speaker, the first audio signal that the processor 130 obtains by applying the mask to the received audio signal may be the voice signal of the first user. However, when the audio signal does not include the voice of the first user, the first audio signal that the processor 130 obtains by applying the mask to the received audio signal may be an attenuated signal.

When an attenuated signal is obtained, the voice recognition based on the first audio signal fails.

As such, when the voice recognition based on the first audio signal fails, the processor 130 identifies a similarity based on the characteristic information of the second audio signal excluding the first audio signal from the received audio signal and the characteristic information of the remaining users of the plurality of users excluding the first user among the plurality of users. The processor 130 changes the target speaker to the second user among the plurality of users using the identified similarity.

To this end, the processor 130 may obtain a second audio signal excluding the first audio signal from the audio signal.

For example, when the voice recognition based on the first audio signal fails, the processor 130 may obtain the second audio signal including a voice signal of another user other than the first user present in the received audio signal based on the first audio signal and the information on a characteristic of the first user.

In an example, the processor 130 may obtain a mask from the artificial intelligence model 121 by inputting the received audio signal and the characteristic information of the first user to the artificial intelligence model 121. In addition, the processor 130 may obtain an audio signal in which the first audio signal is excluded from the received audio signal by obtaining a (1-mask) value and applying the (1-mask) value to the received audio signal, and apply a noise removal technique, such as noise suppression, to the obtained audio signal. In this case, when the received audio signal includes a voice signal of another user other than the first user, the second audio signal obtained through the noise removal technique may be a voice signal of the another user. However, when the received audio signal does not include a voice signal of another user other than the first user, the second audio signal may be an attenuated signal.

As another example, the processor 130 may obtain the second audio signal using a trained artificial intelligence model. The artificial intelligence model may be a model trained to, using characteristic information of a user, generate a mask for separating other voice signals excluding a voice signal having the characteristic information from an audio signal. Such an artificial intelligence model may be called a non-target mask prediction model including CNN, DNN, etc. For example, the processor 130 may input the received audio signal and the characteristic information of the first user to the artificial intelligence model to obtain a mask from the artificial intelligence model. In addition, the processor 130 may apply the mask to the received audio signal. In this case, the mask may be a mask for separating from the audio signal other voice signals excluding a voice signal having the characteristic information (e.g., characteristic information of the first user who is the target speaker) that is input to the artificial intelligence model. In other words, the mask may separate a voice signal having characteristic information of other users excluding a voice signal having specific information of the target speaker from the audio signal, and attenuate other audio signals included in the audio signal. Accordingly, the processor 130 may apply the mask to the audio signal to obtain the second audio signal from the received audio signal. In this case, when the received audio signal includes a voice signal of another user other than the first user, the second audio signal may be a voice signal of the another user. In other words, when the voice recognition based on the first audio signal fails, the processor 130 inputs the first audio signal and the characteristic information of the first user to an artificial intelligence model for obtaining a voice signal of another user other than the user from the audio signal, so that when a voice signal of another user other than the first user exists in the audio signal, the second audio signal including the voice signal of the another other user may be obtained. However, when the received audio signal does not include a voice signal of another user other than the first user, the second audio signal may be an attenuated signal in that there is no voice signal to be separated from the audio signal using the mask.

The processor 130 may identify a similarity between the characteristic information of the second audio signal and the characteristic information of the remaining users other than the first user among the plurality of users.

For example, the processor 130 may obtain a speaker embedding vector of the second audio signal from the second audio signal. In addition, the processor 130 may obtain speaker embedding vectors of the remaining users excluding the speaker embedding vector of the first user among the speaker embedding vectors of the plurality of users stored in the memory 120. The processor 130 may identify a similarity between the speaker embedding vector of the second audio signal and the speaker embedding vectors of the remaining users. The similarity may be a similarity such as a cosine similarity. In this case, when there is one remaining user, the processor 130 may calculate the similarity between the speaker embedding vector of the one remaining user and the speaker embedding vector of the second audio signal. When there are a plurality of remaining users, the processor 130 may calculate a similarity between the speaker embedding vector of each of the plurality of users and the speaker embedding vector of the second audio signal.

For example, it is assumed that the target speaker is set to user A, and the memory 120 stores the speaker embedding vector of user A, the speaker embedding vector of user B, the speaker embedding vector of user C, and the speaker embedding vector of user D.

In this case, the processor 130 may calculate a similarity between the speaker embedding vectors of the remaining users excluding the target speaker, user A, and the speaker embedding vector of the second audio signal. In other words, the processor 130 may calculate a similarity between the speaker embedding vector of user B and the speaker embedding vector of the second audio signal, a similarity between the speaker embedding vector of user C and the speaker embedding vector of the second audio signal, and a similarity between the speaker embedding vector of user D and the speaker embedding vector of the second audio signal.

The processor 130 may then change the target speaker to the second user among the plurality of users based on the identified similarity.

For example, when the similarity between the characteristic information of the second audio signal and the characteristic information of the second user has the greatest value among the identified similarities, the processor 130 may change the target speaker to the second user.

In other words, the processor 130 may identify the similarity having the greatest value among the similarities between the characteristic information of the second audio signal and the characteristic information of the remaining users, identify the user corresponding to the similarity having the greatest value as the new target speaker, and set the identified user as the target speaker.

In this case, when the voice signal included in the received audio signal is a voice signal of the second user, the similarity between the characteristic information of the second audio signal and the characteristic information of the second user may have the greatest value among the similarities between the characteristic information of the second audio signal and the characteristic information of the remaining users.

For example, it is assumed that the voice signal included in the received audio signal is not the voice signal of the first user but the voice signal of the second user. In this case, the second audio signal may be a voice signal of the second user in that there is a voice signal of another user other than the first user in the received audio signal, e.g., the second user. Accordingly, the similarity between the speaker embedding vector of the second audio signal and the speaker embedding vector of the second user among the remaining users may be 1 or a value close to 1, in that the speaker embedding vector of the second user and the speaker embedding vector of the second audio signal are identical (or nearly identical). However, the similarity between the speaker embedding vector of each of the other users excluding the second user and the speaker embedding vector of the second audio signal may be zero or a value close to zero, in that the speaker embedding vector of each of the other users and the speaker embedding vector of the second audio signal are different. Accordingly, the similarity between the characteristic information of the second user among the remaining users and the characteristic information of the second audio signal may be greater than the similarity of the other users.

As such, when the similarity between the characteristic information of the second user and the characteristic information of the second audio signal has the greatest value, the processor 130 may identify that the target speaker is to be changed to the second user, and may change the target speaker from the first user to the second user.

In addition, when the similarity of the second user with the greatest value is greater than a preset (e.g., specified) value, the processor 130 may change the target speaker from the first user to the second user.

In an example, the preset value may be 0.5. However, this is an example, and the preset value may be set in various ways. In other words, since the similarity between the speaker embedding vector of the second user and the speaker embedding vector of the second audio signal is 1 or a value close to 1 and is greater than the preset value, the processor 130 may identify that the target speaker has changed is to be changed to the second user, and change the target speaker from the first user to the second user.

When the similarities between the characteristic information of the second audio signal and the characteristic information of the remaining users are the same, the processor 130 may maintain the first user as the target speaker.

Having the same similarities may include cases where the similarities are not exactly the same, but the difference between the similarities falls within a preset threshold range.

In other words, when the received audio signal does not include a voice signal of any user among the plurality of users, or when the received audio signal does not include any voice signal, the similarities between the characteristic information of the second audio signal and the characteristic information of the remaining users may be the same.

In an example, it is assumed that the voice signal included in the received audio signal is a voice signal of an unregistered user who is not registered with the electronic device 100. In this case, the second audio signal may be a voice signal of the unregistered user in that the received audio signal includes a voice signal of another user other than the first user, e.g., the unregistered user. The speaker embedding vector of the voice signal of the unregistered user is different from the speaker embedding vectors of the remaining users registered with the electronic device 100. Accordingly, the similarities between the speaker embedding vector of the second audio signal and the speaker embedding vectors of the remaining users are zero or a value close to zero, and the similarities can be viewed as identical to each other.

As such, when the similarities between the characteristic information of the second audio signal and the characteristic information of the remaining users are the same, the processor 130 may maintain the first user as the target speaker.

As another example, it is assumed that the received audio signal does not include a voice signal itself. In this case, the second audio signal may be an attenuated signal, in that there is no voice signal to be separated from the received audio signal. Accordingly, the similarities between the speaker embedding vector of the second audio signal and the speaker embedding vectors of the remaining users are zero or a value close to zero, and the similarities can be viewed as identical to each other.

As such, when the similarities between the characteristic information of the second audio signal and the characteristic information of the remaining users are the same, the processor 130 may maintain the first user as the target speaker.

As in the example above, it is assumed that the current target speaker is set to user A.

It is assumed that, among the similarities between the speaker embedding vectors of the second audio signal and the speaker embedding vectors of users B, C, and D, the similarity between the speaker embedding vector of the second audio signal and the speaker embedding vector of user B is the greatest. In this case, the processor 130 may identify user B as the new target speaker, and may change the target speaker from user A to user B.

However, when the similarities between the speaker embedding vector of the second audio signal and the speaker embedding vectors of users B, C, and D have a value of zero or a value close to zero, the processor 130 may maintain user A as the target speaker.

In the above example, it is descried that the target speaker is selected by comparing the characteristic information of the second audio signal with the characteristic information of the remaining users.

Further, according to an embodiment of the present disclosure, the target speaker may be selected based on a similarity to a user currently set as the target speaker.

For example, the processor 130 may identify a similarity based on the characteristic information of the first audio signal, the characteristic information of the second audio signal excluding the first audio signal from the received audio signal, and the characteristic information of the plurality of users, and change the target speaker to the second user among the plurality of users using the identified similarity.

The processor 130 may identify a similarity between the characteristic information of the first audio signal and the characteristic information of the first user.

In other words, the processor 130 may obtain the speaker embedding vector of the first audio signal from the first audio signal. In addition, the processor 130 may obtain the speaker embedding vector of the first user among the speaker embedding vectors of the plurality of users stored in the memory 120. Subsequently, the processor 130 may identify a similarity between the speaker embedding vector of the first audio signal and the speaker embedding vector of the first user. Here, the similarity may be a similarity such as a cosine similarity.

The processor 130 may obtain the second audio signal excluding the first audio signal from the audio signal. In addition, the processor 130 may identify similarities between the characteristic information of the second audio signal and the characteristic information of the remaining users excluding the first user among the plurality of users. In this case, the method for acquiring the second audio signal and the method for identifying the similarities between the characteristic information of the second audio signal and the characteristic information of the remaining users are the same as described above.

The processor 130 may change the target speaker to the second user based on the identified similarities.

For example, the processor 130 may change the target speaker to the second user when the greatest value of the similarity between the characteristic information of the second audio signal and the characteristic information of each of the remaining users is the similarity between the characteristic information of the second audio signal and the characteristic information of the second user, and the corresponding similarity is greater than the similarity between the characteristic information of the first audio signal and the characteristic information of the first user.

In other words, the processor 130 may identify a similarity having the greatest value among the similarities between the characteristic information of the second audio signal and the characteristic information of each of the remaining users. The processor 130 may compare the similarity having the greatest value with the similarity between the characteristic information of the first audio signal and the characteristic information of the first user. In this case, when the similarity having the greatest value is greater than the similarity between the characteristic information of the first audio signal and the characteristic information of the first user and a predetermined threshold value, the processor 130 may identify the user corresponding to the similarity as the target speaker, and may set the identified user as the target speaker.

In this case, when the voice signal included in the received audio signal is a voice signal of the second user, the similarity between the characteristic information of the second audio signal and the characteristic information of the second user may be greater than the similarity between the characteristic information of the first audio signal and the characteristic information of the first user.

For example, it is assumed that the voice signal included in the received audio signal is the voice signal of the second user, not the voice signal of the first user.

In this case, the first audio signal may be an attenuated signal in that the first user voice signal is not present in the received audio signal. Accordingly, the similarity between the speaker embedding vector of the first audio signal and the speaker embedding vector of the first user may be zero or a value close to zero. The second audio signal may be a voice signal of the second user in that the received audio signal includes a voice signal of another user other than the first user, e.g., the second user. Accordingly, the similarity between the speaker embedding vector of the second audio signal and the speaker embedding vector of the second user among the remaining users may be 1 or a value close to 1, in that the speaker embedding vector of the second user and the speaker embedding vector of the second audio signal are identical (or nearly identical). However, the similarity between the speaker embedding vector of each of the other users and the speaker embedding vector of the second audio signal may be zero or a value close to zero, in that the speaker embedding vector of each of the other users and the speaker embedding vector of the second audio signal are different.

As such, when the similarity between the characteristic information of the second user and the characteristic information of the second audio signal has the greatest value, and the corresponding similarity is greater than the similarity between the characteristic information of the first user and the characteristic information of the first audio signal, the processor 130 may identify that the target speaker is to be changed to the second user, and may change the target speaker from the first user to the second user.

In addition, the processor 130 may change the target speaker from the first user to the second user when the similarity having the greatest value is greater than the similarity between the characteristic information of the first user and the characteristic information of the first audio signal and a preset value.

In an example, the preset value may be 0.5. However, this is an example, and the preset value may be set in various ways. In other words, in that the similarity between the speaker embedding vector of the second user and the speaker embedding vector of the second audio signal is 1 or a value close to 1, and the similarity is greater than the similarity between the speaker embedding vector of the first user and the speaker embedding vector of the first audio signal and the preset value, the processor 130 may identify that the target speaker is to be changed to the second user, and may change the target speaker from the first user to the second user.

The processor 130 may maintain the first user as the target speaker when the similarity between the characteristic information of the first audio signal and the characteristic information of the first user is equal to or greater than the similarities between the characteristic information of the second audio signal and the characteristic information of the remaining users.

Having the same similarities may include a case where the similarities are not exactly the same, but the difference between the similarities falls within a preset threshold range.

In other words, when the voice signal included in the received audio signal is the voice signal of the first user, the similarity between the characteristic information of the first audio signal and the characteristic information of the first user may be greater than the similarity between the characteristic information of the second audio signal and the characteristic information of the remaining users.

For example, it is assumed that the voice signal included in the received audio signal is the voice signal of the first user.

In this case, the first audio signal may be a voice signal of the first user separated from the received audio signal. Accordingly, the similarity between the speaker embedding vector of the first audio signal and the speaker embedding vector of the first user may be 1 or a value close to 1. The received audio signal does not include a voice signal of another user other than the first user. Therefore, the second audio signal may be an attenuated signal. Accordingly, the similarities between the speaker embedding vector of the second audio signal and the speaker embedding vectors of the remaining users may be zero or a value close to zero.

As such, when the similarity between the characteristic information of the first user and the characteristic information of the first audio signal is greater than the similarity between the characteristic information of the remaining users and the characteristic information of the second audio signal, the processor 130 may maintain the first user as the target speaker.

Further, when the received audio signal includes neither a voice signal of any of the plurality of users nor any voice signal, the similarity between the characteristic information of the first user and the characteristic information of the first audio signal and the similarity between the characteristic information of the remaining users and the characteristic information of the second audio signal may be the same.

In an example, it is assumed that the voice signal included in the received audio signal is the voice signal of an unregistered user who is not registered with the electronic device 100. In this case, the received audio signal does not include the voice signal of the first user, in that the first user is a registered user of the electronic device 100. Therefore, the first audio signal may be an attenuated signal. Accordingly, the similarity between the speaker embedding vector of the first audio signal and the speaker embedding vector of the first user may be zero or a value close to zero. The second audio signal may be an audio signal of an unregistered user, in that there is an audio signal of another user other than the first user in the received audio signal, e.g., an unregistered user. The speaker embedding vector of the voice signal of the unregistered user is different from the speaker embedding vectors of the remaining users registered with the electronic device 100. Accordingly, the similarity between the speaker embedding vector of the second audio signal and the speaker embedding vectors of the remaining users may be zero or a value close to zero.

Accordingly, the similarity between the characteristic information of the first user and the characteristic information of the first audio signal and the similarity between the characteristic information of the remaining users and the characteristic information of the second audio signal may be viewed as equal to each other. In this case, the processor 130 may maintain the first user as the target speaker.

As another example, it is assumed that the received audio signal does not include a voice signal itself. In this case, the first and second audio signals may be attenuated signals, in that there is no voice signal to be separated from the received audio signal. Accordingly, the similarity between the speaker embedding vector of the first audio signal and the speaker embedding vector of the first user and the similarities between the speaker embedding vector of the second audio signal and the speaker embedding vectors of the remaining users may be zero or a value close to zero, and they can be viewed as equal to each other. In this case, the processor 130 may maintain the first user as the target speaker.

As in the example above, it is assumed that the current target speaker is set to user A.

In this case, it is assumed that the similarity between the speaker embedding vector of the second audio signal and the speaker embedding vector of user B is the greatest among the similarities between the speaker embedding vector of the second audio signal and the speaker embedding vectors of users B, C or D. In this case, the processor 130 may compare the similarity between the speaker embedding vector of the second audio signal and the speaker embedding vector of user B with the similarity between the speaker embedding vector of the first audio signal and the speaker embedding vector of user A. In this case, when the similarity between the speaker embedding vector of the second audio signal and the speaker embedding vector of user B is greater than the similarity between the speaker embedding vector of the first audio signal and the speaker embedding vector of user A and a preset threshold value, the processor 130 may identify user B as a new target speaker, and the target speaker may be changed from user A to user B.

However, the processor 130 may maintain user A as the target speaker when the similarity between the speaker embedding vector of the first audio signal and the speaker embedding vector of user A is equal to or greater than the similarities between the speaker embedding vector of the second audio signal and the speaker embedding vectors of users B, C or D.

When the target speaker is changed to the second user, the processor 130 may input the characteristic information of the second user and the received audio signal to the artificial intelligence model 121 to obtain the voice signal of the second user from the received audio signal.

In other words, when the similarity between the characteristic information of the second user and the characteristic information of the second audio signal is the greatest among the similarity between the characteristic information of the remaining users excluding the first user and the characteristic information of the second audio signal, it can be considered that the received audio signal includes the voice signal of the second user rather than the voice signal of the first user.

When the similarity between the characteristic information of the second user and the characteristic information of the second audio signal is greater than the similarity between the characteristic information of the first user and the characteristic information of the first audio signal, it can be considered that the received audio signal includes the voice signal of the second user rather than the voice signal of the first user.

In this case, the processor 130 may change the target speaker from the first user to the second user.

Accordingly, the processor 130 may update the characteristic information input to the artificial intelligence model 121 from the characteristic information of the first user to the characteristic information of the second user, and input the characteristic information of the second user and the received audio signal to the artificial intelligence model 121. The processor 130 may obtain the voice signal of the second user from the audio signal using a mask obtained from the artificial intelligence model 121.

Further, the processor 130 may perform voice recognition based on the voice signal of the second user. For example, the processor 130 may provide a response to the voice of the second user using a dialog system.

As such, according to the present disclosure, the electronic device 100 may obtain the voice of the corresponding speaker from the audio signal using the characteristic information of the speaker who is the subject of the current utterance. In other words, the electronic device 100 may set the user who is the subject of the current utterance as the target speaker and input the speaker embedding vector of the corresponding user to the artificial intelligence model to obtain the voice of the corresponding user, even without manually changing the setting for the target speaker. Accordingly, the efficiency of voice recognition can be improved.

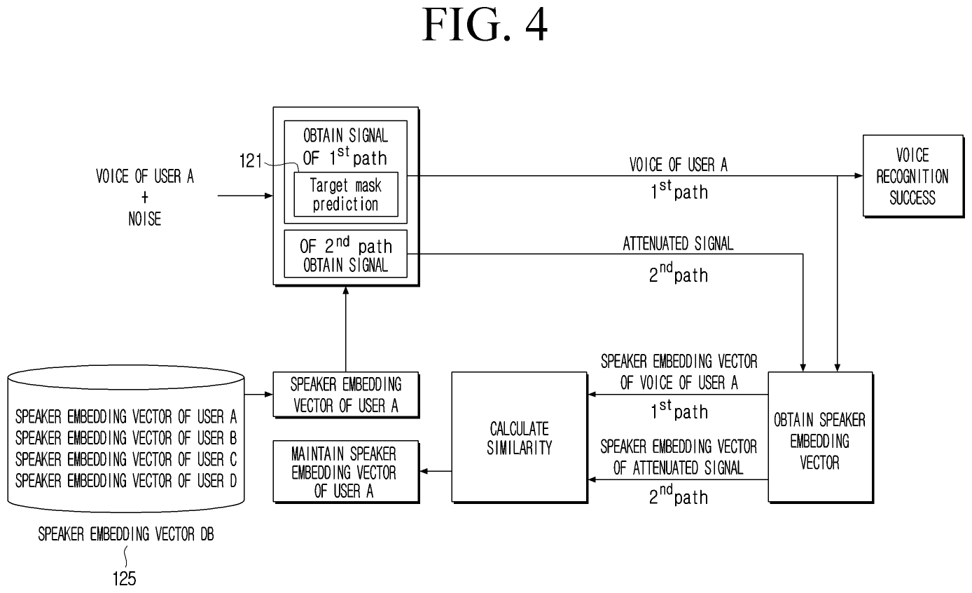

FIGS. 4, 5, 6, 7 and 8 are diagrams illustrating example methods of updating a speaker embedding vector that is input to an artificial intelligence model according to various embodiments.

In FIGS. 4, 5, 6, 7 and 8 (which may be referred to as FIGS. 4 to 8), it is assumed that a speaker embedding vector DB 125 including speaker embedding vectors of users A, B, C, and D is stored in the memory 120.

FIG. 4 assumes that the audio signal received through the voice reception unit 110 includes a voice signal and noise of user A, and that the target speaker is set to user A.

Referring to FIG. 4, when an audio signal is received through the voice reception unit 110, the processor 130 may obtain the signal of the first path using the received audio signal and the speaker embedding vector of the target speaker, e.g., user A.

In the present disclosure, when the voice signal of the target speaker is present in the received audio signal, the first path may be a path in which the voice signal of the target speaker obtained from the received audio signal is processed. However, when the voice signal of the target speaker is not present in the received audio signal, the signal of the first path may be an attenuated signal.

For example, the processor 130 may obtain a mask by inputting the received audio signal and the speaker embedding vector of user A to the target mask prediction model 121. The mask may be a mask for separating the voice signal of the target speaker, e.g., user A, from the received audio signal.

In this case, the processor 130 may obtain the voice signal of user A from the audio signal through the mask, in that the received audio signal includes the voice signal of user A. Further, the processor 130 may perform voice recognition on the signal of the first path. In this case, the voice recognition may be performed successfully, in that the signal of the first path is the voice signal of user A.

The processor 130 may obtain the signal of the second path using the received audio signal and the speaker embedding vector of user A.

In the present disclosure, when the voice signal of another user other than the voice signal of the target speaker, e.g., user A, is present in the received audio signal, the second path may be a path in which the voice signal of the another user obtained from the received audio signal is processed. However, when the voice signal of another user is not present in the received audio signal, the signal of the second path may be an attenuated signal.

In this case, the signal that the processor 130 obtains from the received audio signal may be an attenuated signal, in that the received audio signal does not include the voice signal of another user other than the target speaker, e.g., user A. The processor 130 may obtain a speaker embedding vector for the signal of the first path and the signal of the second path.

The processor 130 may select a target speaker using the obtained speaker embedding vector.

In an example, the processor 130 may calculate similarities between the speaker embedding vector obtained from the signal of the second path and the speaker embedding vectors of the remaining users excluding the target speaker, user A (e.g., the speaker embedding vectors of users B, C, and D) among the speaker embedding vectors stored in the speaker embedding vector DB 125. In other words, the processor 130 may calculate the similarity between the speaker embedding vector obtained from the signal of the second path and the speaker embedding vector of user B, the similarity between the speaker embedding vector obtained from the signal of the second path and the speaker embedding vector of user C, and the similarity between the speaker embedding vector obtained from the signal of the second path and the speaker embedding vector of user D. In this case, the calculated similarities may be zero or a value close to zero, in that the signal of the second path is an attenuated signal.

In this case, the processor 130 may maintain user A as the target speaker, in that the similarities of users B, C, and D have the same value to each other. In other words, the processor 130 may maintain the speaker embedding vector input to the target mask prediction model 121 as the speaker embedding vector of user A.

As another example, the processor 130 may calculate a similarity between the speaker embedding vector obtained from the signal of the first path and the speaker embedding vector of the target speaker, user A. In this case, the similarity between the speaker embedding vector obtained from the signal of the first path and the speaker embedding vector of user A may be 1 or a value close to 1, in that the signal of the first path is the voice signal of user A.

The processor 130 may calculate similarities between the speaker embedding vector obtained from the signal of the second path and the speaker embedding vectors of the remaining users excluding the speaker embedding vector of the target speaker, user A (e.g., the speaker embedding vectors of users B, C, and D) among the speaker embedding vectors stored in the speaker embedding vector DB 125. In this case, the calculated similarities may be zero or a value close to zero, in that the signal of the second path is an attenuated signal.

In this case, the processor 130 may maintain user A as the target speaker, in that the similarity of user A is greater than the similarities of users B, C, and D. In other words, the processor 130 may maintain the speaker embedding vector input to the target mask prediction model 121 as the speaker embedding vector of user A.

As such, when the voice of the target speaker is received, the processor 130 may obtain the voice of the target speaker from the audio signal using the speaker embedding vector of the target speaker, and perform voice recognition on the obtained voice.

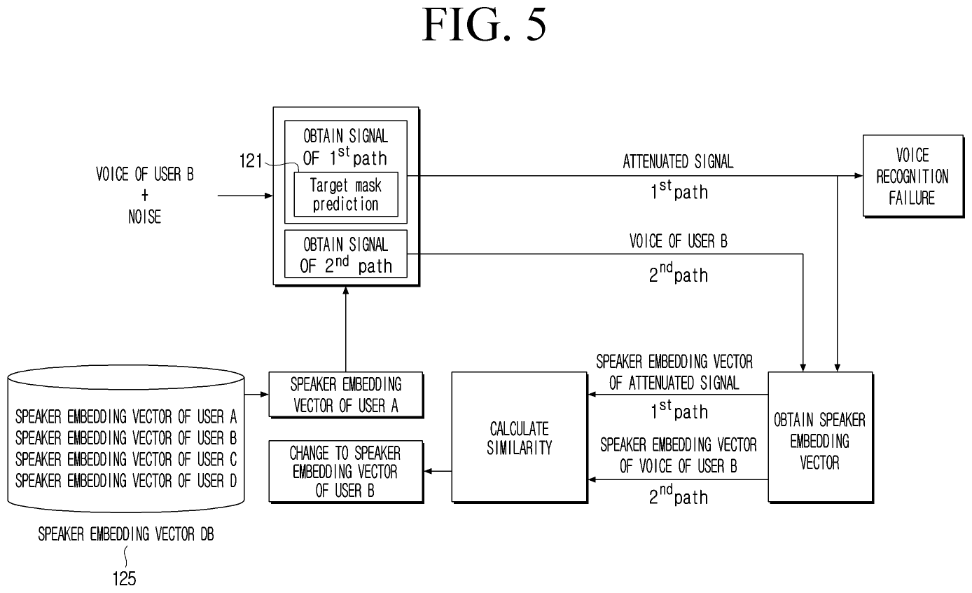

Referring to FIG. 5, it is assumed that the audio signal received through the voice reception unit 110 includes the voice signal and noise of user B, and the target speaker is set to user A.

Referring to FIG. 5, when an audio signal received through the voice reception unit 110, the processor 130 may obtain the signal of the first path using the received audio signal and the speaker embedding vector of the target speaker, user A.

For example, the processor 130 may obtain a mask by inputting the received audio signal and the speaker embedding vector of the user A to the target mask prediction model 121. The mask may be a mask for separating the voice signal of the target speaker, user A, from the received audio signal.

In this case, the signal that the processor 130 obtains from the audio signal through the mask may be an attenuated signal in that the received audio signal does not include the voice signal of user A. In other words, the signal of the first path may be an attenuated signal.

In addition, the processor 130 may perform voice recognition on the signal of the first path. In this case, the voice recognition will fail since the signal of the first path is an attenuated signal.

The processor 130 may obtain the signal of the second path using the received audio signal and the speaker embedding vector of user A.

In this case, the signal that the processor 130 obtains from the received audio signal may be the voice signal of user B, in that the received audio signal includes the voice signal of user B. In other words, the signal of the second path may be the voice signal of user B.

The processor 130 may obtain a speaker embedding vector for the signal of the first path and the signal of the second path.

The processor 130 may select a target speaker using the obtained speaker embedding vector.

In an example, the processor 130 may calculate similarities between the speaker embedding vector obtained from the signal of the second path and the speaker embedding vectors of the remaining users excluding the target speaker, user A (e.g., the speaker embedding vectors of users B, C, and D) among the speaker embedding vectors stored in the speaker embedding vector DB 125. In this case, in that the signal of the second path is the voice signal of user B, the similarity between the speaker embedding vector obtained from the signal of the second path and the speaker embedding vector of user B may be 1 or a value close to 1, and the similarities between the speaker embedding vector obtained from the signal of the second path and the speaker embedding vectors of users C, D may be zero or a value close to zero, respectively.

In this case, since user B has the greatest value of similarity, the processor 130 may change the target speaker to user B, and change the speaker embedding vector input to the target mask prediction model 121 from the speaker embedding vector of user A to the speaker embedding vector of user B.

As another example, the processor 130 may calculate a similarity between the speaker embedding vector obtained from the signal of the first path and the speaker embedding vector of the target speaker, user A. In this case, in that the signal of the first path is an attenuated signal, the similarity between the speaker embedding vector obtained from the attenuated signal and the speaker embedding vector of user A may be zero or a value close to zero.

Further, the processor 130 may calculate similarities between the speaker embedding vector obtained from the signal of the second path and the speaker embedding vectors of the remaining users excluding the speaker embedding vector of the target speaker, user A (e.g., the speaker embedding vectors of users B, C, and D) among the speaker embedding vectors stored in the speaker embedding vector DB 125. In this case, among users B, C, and D, user B has the greatest value of similarity, and in that the similarity of user B is greater than the similarity of user A, processor 130 may change the target speaker to user B, and change the speaker embedding vector input to target mask prediction model 121 from the speaker embedding vector of user A to the speaker embedding vector of user B.

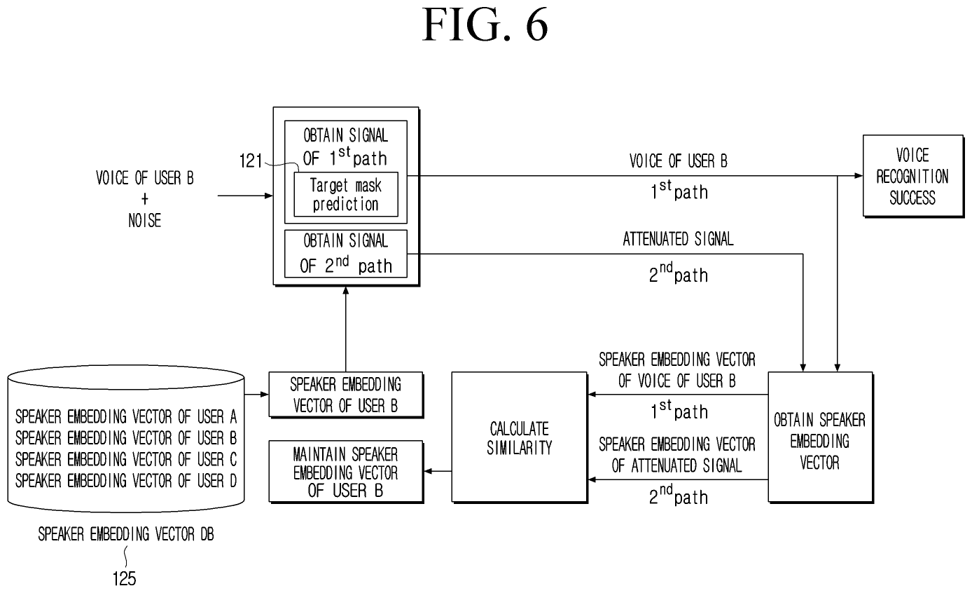

As shown in FIG. 6, the processor 130 may obtain the signal of the first path using the received audio signal and the speaker embedding vector of the target speaker, user B.

For example, the processor 130 may obtain a mask by inputting the received audio signal and the speaker embedding vector of user B to the target mask prediction model 121. The mask may be a mask for separating the voice signal of the target speaker, user B, from the received audio signal.

In this case, in that the received audio signal includes the voice signal of user B, the processor 130 may obtain the voice signal of user B from the audio signal through the mask. In other words, the signal of the first path may be the voice signal of user B.

Further, the processor 130 may perform voice recognition on the signal of the first path. In this case, the voice recognition may be performed successfully, in that the signal of the first path is the voice signal of user B.

The processor 130 may obtain the signal of the second path using the received audio signal and the speaker embedding vector of user B.

In this case, the signal that the processor 130 obtains from the received audio signal may be an attenuated signal, in that the received audio signal does not include a voice signal of any user other than the target speaker, user B. In other words, the signal of the second path may be an attenuated signal.

The processor 130 may obtain a speaker embedding vector for the signal of the first path and the signal of the second path.

The processor 130 may select a target speaker using the obtained speaker embedding vector.

In an example, the processor 130 may calculate similarities between the speaker embedding vector obtained from the signal of the second path and the speaker embedding vectors of the remaining users excluding the speaker embedding vector of the target speaker, user B (e.g., the speaker embedding vectors of users A, C, and D) among the speaker embedding vectors stored in the speaker embedding vector DB 125. In this case, in that the signal of the second path is an attenuated signal, the similarities between the speaker embedding vector obtained from the signal of the second path and the speaker embedding vectors of users A, C, and D may be zero or a value close to zero, respectively.

In this case, the processor 130 may maintain user B as the target speaker, in that the similarities of users A, C, and D have the same value to each other. In other words, the processor 130 may maintain the speaker embedding vector input to the target mask prediction model 121 as the speaker embedding vector of user B.

As another example, the processor 130 may calculate a similarity between the speaker embedding vector obtained from the signal of the first path and the speaker embedding vector of the target speaker, user B. In this case, the similarity between the speaker embedding vector obtained from the signal of the first path and the speaker embedding vector of user B may be 1 or a value close to 1, in that the signal of the first path is the voice signal of user B.

Further, the processor 130 may calculate similarities between the speaker embedding vector obtained from the signal of the second path and the speaker embedding vectors of the remaining users excluding the speaker embedding vector of the target speaker, user B (e.g., the speaker embedding vectors of users A, C, and D) among the speaker embedding vectors stored in the speaker embedding vector DB 125. In this case, in that the signal of the second path is an attenuated signal, the similarities between the speaker embedding vector obtained from the signal of the second path and the speaker embedding vectors of users A, C, and D may be zero or a value close to zero, respectively.

In this case, the processor 130 may maintain user B as the target speaker, in that the similarity of user B is greater than the similarities of users A, C, and D. In other words, the processor 130 may maintain the speaker embedding vector input to the target mask prediction model 121 as the speaker embedding vector of user B.

As such, when the target speaker is changed, the processor 130 may obtain the voice of the changed target speaker from the received audio signal using the speaker embedding vector of the changed target speaker, and perform voice recognition on the obtained voice.

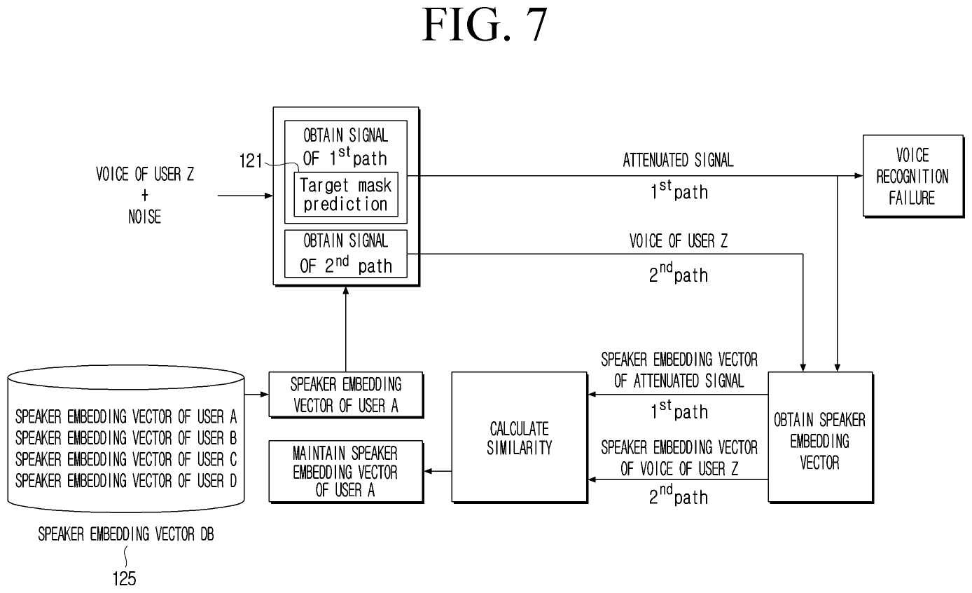

In FIG. 7, it is assumed that the audio signal received through the voice reception unit 110 includes a voice signal and noise of user Z, and the target speaker is set to user A. Here, user Z is a user who is not registered with the electronic device 100.

Referring to FIG. 7, when an audio signal is received through the voice reception unit 110, the processor 130 may obtain the signal of the first path using the received audio signal and the speaker embedding vector of the target speaker, user A.

For example, the processor 130 may obtain a mask by inputting the received audio signal and the speaker embedding vector of user A to the target mask prediction model 121. The mask may be a mask for separating the voice signal of the target speaker, user A, from the received audio signal.

In this case, the signal that the processor 130 obtains from the audio signal through the mask may be an attenuated signal, in that the received audio signal does not include the voice signal of user A. In other words, the signal of the first path may be an attenuated signal.

In addition, the processor 130 may perform voice recognition on the signal of the first path. In this case, the voice recognition will fail since the signal of the first path is an attenuated signal.

The processor 130 may obtain the signal of the second path using the received audio signal and the speaker embedding vector of user A.

In this case, the signal that the processor 130 obtains from the received audio signal may be the voice signal of user Z, in that the received audio signal does not include a voice signal of any user other than user Z. In other words, the signal of the second path may be the voice signal of user Z.

The processor 130 may obtain a speaker embedding vector for the signal of the first path and the signal of the second path.

The processor 130 may select a target speaker using the obtained speaker embedding vector.

For example, the processor 130 may calculate similarities between the speaker embedding vector obtained from the signal of the second path and the speaker embedding vectors of the remaining users excluding the speaker embedding vector of the target speaker, user B (e.g., the speaker embedding vectors of users A, C, and D) among the speaker embedding vectors stored in the speaker embedding vector DB 125. In this case, in that the signal of the second path is the voice signal of user Z, the similarity between the speaker embedding vector obtained from the signal of the second path and the speaker embedding vectors of users B, C, and D may be zero or a value close to zero, respectively.

In this case, the processor 130 may maintain user A as the target speaker, in that the similarities of users B, C, and D have the same value to each other. In other words, the processor 130 may maintain the speaker embedding vector input to the target mask prediction model 121 as the speaker embedding vector of user A.

As another example, the processor 130 may calculate a similarity between the speaker embedding vector obtained from the signal of the first path and the speaker embedding vector of the target speaker, user A. In this case, in that the signal of the first path is an attenuated signal, the similarity between the speaker embedding vector obtained from the attenuated signal and the speaker embedding vector of user A may be zero or a value close to zero.

Further, the processor 130 may calculate similarities between the speaker embedding vector obtained from the signal of the second path and the speaker embedding vectors of the remaining users excluding the speaker embedding vector of the target speaker, user A (e.g., the speaker embedding vectors of users B, C, and D) among the speaker embedding vectors stored in the speaker embedding vector DB 125. In this case, in that the signal of the second path is the voice signal of user Z, the similarity between the speaker embedding vector obtained from the signal of the second path and the speaker embedding vectors of users B, C, and D may be zero or a value close to zero, respectively.

In this case, the processor 130 may maintain user A as the target speaker, in that users A, B, C, and D have the same similarity to each other. In other words, the processor 130 may maintain the speaker embedding vector input to the target mask prediction model 121 as the speaker embedding vector of user A.

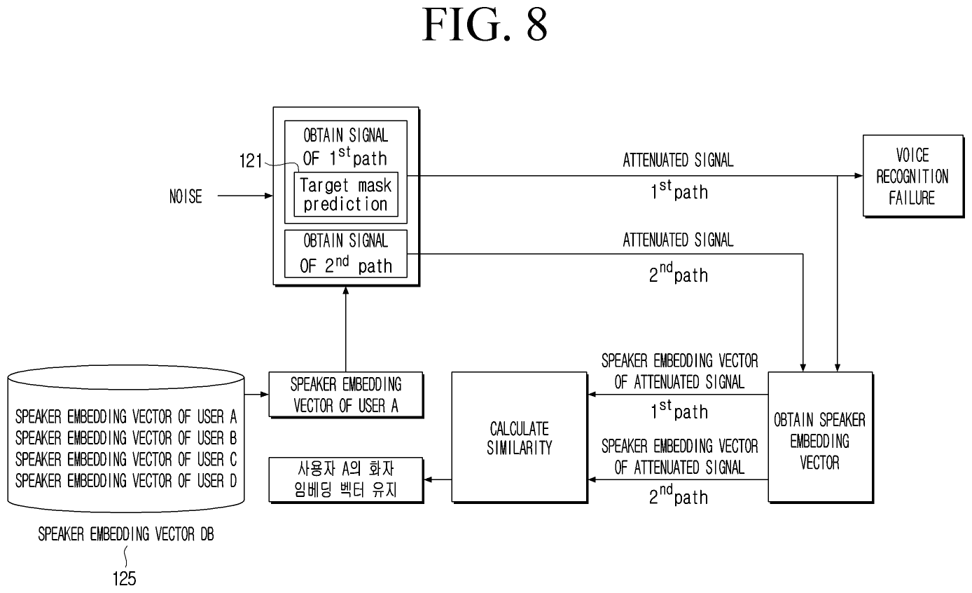

In FIG. 8, it is assumed that the audio signal received through the voice reception unit 110 includes noise, and the target speaker is set to be User A.

Referring to FIG. 8, when an audio signal is received through the voice reception unit 110, the processor 130 may obtain the signal of the first path using the received audio signal and the speaker embedding vector of the target speaker, user A.

For example, the processor 130 may obtain a mask by inputting the received audio signal and the speaker embedding vector of user A to the target mask prediction model 121. The mask may be a mask for separating the voice signal of user A from the received audio signal.

In this case, the signal that the processor 130 obtains from the audio signal through the mask may be an attenuated signal, in that the received audio signal does not include any voice signal. In other words, the signal of the first path may be an attenuated signal.

In addition, the processor 130 may perform voice recognition on the signal of the first path. In this case, the voice recognition will fail since the signal of the first path is an attenuated signal.

The processor 130 may obtain the signal of the second path using the received audio signal and the speaker embedding vector of user A.

In this case, the signal that the processor 130 obtains from the received audio signal may be an attenuated signal, in that the received audio signal does not include any voice signal. In other words, the signal of the second path may be an attenuated signal.

The processor 130 may obtain a speaker embedding vector for the signal of the first path and the signal of the second path.

The processor 130 may select a target speaker using the obtained speaker embedding vector.

For example, the processor 130 may calculate similarities between the speaker embedding vector obtained from the signal of the second path and the speaker embedding vectors of the remaining users excluding the speaker embedding vector of the target speaker, user A (e.g., the speaker embedding vectors of users B, C, and D) among the speaker embedding vectors stored in the speaker embedding vector DB 125. In this case, in that the signal of the second path is an attenuated signal, the similarities between the speaker embedding vector obtained from the signal of the second path and the speaker embedding vectors of users B, C, and D may be zero or a value close to zero, respectively.

In this case, the processor 130 may maintain user A as the target speaker, in that the similarities of users B, C, and D have the same value to each other. In other words, the processor 130 may maintain the speaker embedding vector input to the target mask prediction model 121 as the speaker embedding vector of user A.

As another example, the processor 130 may calculate a similarity between the speaker embedding vector obtained from the signal of the first path and the speaker embedding vector of the target speaker, user A. In this case, in that the signal of the first path is an attenuated signal, the similarity between the speaker embedding vector obtained from the attenuated signal and the speaker embedding vector of user A may be zero or a value close to zero.

Further, the processor 130 may calculate similarities between the speaker embedding vector obtained from the signal of the second path and the speaker embedding vectors of the remaining users excluding the speaker embedding vector of the target speaker, user A (e.g., the speaker embedding vectors of users B, C, and D) among the speaker embedding vectors stored in the speaker embedding vector DB 125. In this case, in that the signal of the second path is an attenuated signal, the similarities between the speaker embedding vector obtained from the signal of the second path and the speaker embedding vectors of users B, C, and D may be zero or a value close to zero, respectively.

In this case, the processor 130 may maintain the target speaker as user A, in that users A, B, C, and D have the same similarity to each other. In other words, the processor 130 may maintain the speaker embedding vector input to the target mask prediction model 121 as the speaker embedding vector of user A.

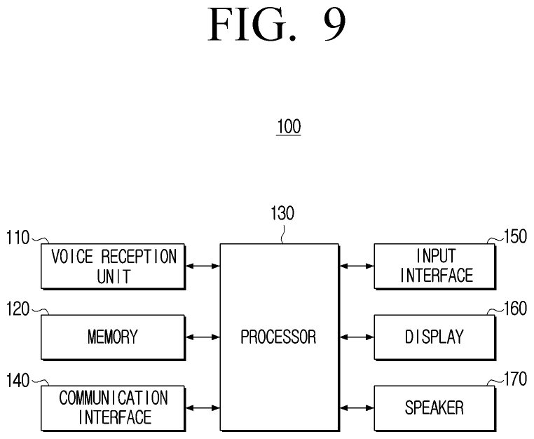

FIG. 9 is a block diagram illustrating an example configuration of an electronic device according to various embodiments.

Referring to FIG. 9, the electronic device 100 may further include a communication interface (e.g., including communication circuitry) 140, an input interface (e.g., including input circuitry) 150, a display 160, and a speaker 170 in addition to the voice reception unit 110, the memory 120, and the processor 130. However, these configurations are examples, and that new configurations may be added in addition to these configurations or some configurations may be omitted in implementing the present disclosure. In describing FIG. 9, duplicative descriptions of FIGS. 1 to 8 may not be repeated here.

The communication interface 140 includes circuitry. The communication interface 140 may perform communication with an external electronic device. To this end, the communication interface 140 may perform communication with the external electronic device over a network using a Bluetooth module, a Wi-Fi module, a mobile communication module (e.g., LTE), or the like. Accordingly, the processor 130 may transmit and receive various data to and from the external electronic device through the communication interface 140.

The input interface 150 includes circuitry. The input interface 150 may receive a user input. For example, the input interface 150 may include a plurality of buttons. As another example, the input interface 150 may receive a remote control signal from a remote controller for controlling the electronic device 100. As another example, the input interface 150 may be implemented as a touch screen. In this case, when a user input is received through the input interface 150, the processor 130 may perform an operation corresponding to the user input.

The display 160 may display an image. For example, the processor 130 may output various images through the display 160. For example, the processor 130 may display a screen on the display 160 that includes a response to a user voice. To this end, the display 160 may be implemented as various types of displays, such as LCDs, LEDs, or OLEDs.

The speaker 170 may output audio. For example, the processor 130 may output various notification sounds or voice guide messages related to the operations of the electronic device 100 through the speaker 170. For example, the processor 130 may output a voice response to a user voice through the speaker 170.

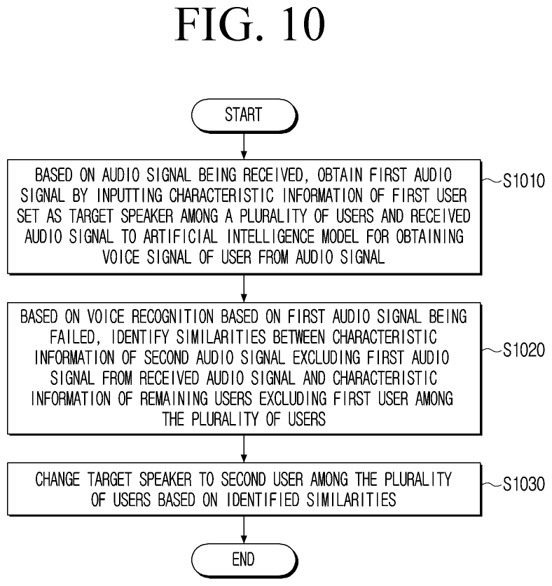

FIG. 10 is a flowchart illustrating an example method of updating a target speaker of an electronic device according to various embodiments.

When an audio signal is received, a first audio signal is obtained by inputting information on a characteristic of a first user set as a target speaker among a plurality of users and the received audio signal are input to an artificial intelligence model for obtaining a voice signal of the speaker from the audio signal (S1010).

When voice recognition based on the first audio signal failing, a similarity between the characteristic information of a second audio signal excluding the first audio signal from the received audio signal and the characteristic information of the remaining users excluding the first user among the plurality of users is identified (S1020).

Based on the identified similarity, the target speaker is changed to a second user among the plurality of users (S1030).

For example, operation S1030 may include, when the similarity between the characteristic information of the second audio signal and the characteristic information of the second user has the greatest value, changing the target speaker to the second user among the identified similarities.

The characteristic information of the plurality of users may be speaker embedding vectors of the plurality of users. In this case, operation S1020 may include identifying similarities between the speaker embedding vector of the second audio signal and the speaker embedding vectors of the remaining users.

When the voice signal included in the received audio signal is the voice signal of the second user, the similarity between the characteristic information of the second audio signal and the characteristic information of the second user may have the greatest value among the identified similarities.

Further, when the identified similarities are the same to each other, the first user may be maintained as the target speaker.

When the received audio signal does not include a voice signal from any of the plurality of users, or when the received audio signal does not include any voice signal, the identified similarities may be same to each other.

When the target speaker is changed to the second user, the voice signal of the second user from the received audio signal may be obtained by inputting the characteristic information of the second user and the received audio signal to the artificial intelligence model.

Voice recognition may be performed based on the second user voice signal.

The functions associated with artificial intelligence according to the present disclosure are operated through the processor 130 and the memory 120.

The processor 130 may include one or more processors 130. In this case, the one or more processors 130 may be a general-purpose processor such as a CPU, an AP, etc., a graphics-only processor such as a GPU, a VPU, etc., or an artificial intelligence-only processor such as an NPU.

The one or more processors 130 may control to process the input data based on a predefined operation rule or an artificial intelligence model stored in the memory 120. The predefined operation rule or artificial intelligence model may be acquired by the learning.

Here, “acquired by the learning” may indicate that the predefined operation rule or artificial intelligence model of a desired feature is acquired by applying a learning algorithm to a lot of learning data. Such learning may be performed on a device itself where the artificial intelligence is performed according to an embodiment, or by a separate server/system.

The artificial intelligence model may include a plurality of neural network layers. Each layer may have at least a plurality of weight values, and calculation of the layer may be performed through an operation result of a previous layer and an operation of the plurality of weight values. Examples of the neural network may include a convolutional neural network (CNN), a deep neural network (DNN), a recurrent neural network (RNN), a restricted Boltzmann machine (RBM), a deep belief network (DBN), a bidirectional recurrent deep neural network (BRDNN), a deep Q-network, or the like, and the neural network in this disclosure is not limited to the above examples.

The learning algorithm may include a method of training a predetermined target device (e.g., robot) using a large number of learning data for the predetermined target device to make a decision or a prediction by itself. The learning algorithms may include, for example, a supervised learning algorithm, an unsupervised learning algorithm, a semi-supervised learning algorithm, or a reinforcement learning algorithm, and the learning algorithm of this disclosure is not limited to the above-described examples, unless specified otherwise.

According to an embodiment, the methods according to the various embodiments disclosed herein may be included and provided in a computer program product. The computer program product may be traded as a product between a seller and a purchaser. The computer program product may be traded as a product between a seller and a purchaser. The computer program product can be distributed in the form of a storage medium that is readable by machines (e.g.: a compact disc read only memory (CD-ROM)), or distributed directly on-line (e.g.: download or upload) through an application store (e.g.: PlayStore™), or between two user devices (e.g.: smartphones). In the case of on-line distribution, at least a portion of a computer program product (e.g.: a downloadable app) may be stored in a storage medium readable by machines such as the server of the manufacturer, the server of the application store, or the memory 140 of the relay server at least temporarily, or may be generated temporarily.

As described above, each of the components (e.g., modules or programs) according to the various embodiments may include a single entity or a plurality of entities, and some of the corresponding sub-components described above may be omitted or other sub-components may be further included in the various embodiments. Alternatively or additionally, some of the components (e.g., the modules or the programs) may be integrated into one entity, and may perform functions performed by the respective corresponding components before being integrated in the same or similar manner.

Operations performed by the modules, the programs or other components according to the various embodiments may be executed in a sequential manner, a parallel manner, an iterative manner or a heuristic manner, and at least some of the operations may be performed in a different order or be omitted, or other operations may be added.

A non-transitory computer readable medium storing a program for sequentially performing the controlling method according to the present disclosure may be provided. The non-transitory computer-readable medium refers to a medium that stores data. For example, the above-described various applications or programs may be stored and provided in a non-transitory computer-readable medium such as CD, DVD, hard disk, Blu-ray disk, USB, memory card, ROM, etc.

In addition, various embodiments of the present disclosure may be implemented in software including an instruction stored in a machine-readable storage medium (e.g., computer). The machine may be a device that invokes the stored instruction from the storage medium and is operated based on the invoked instruction, and may include an electronic device (e.g., electronic device 100) according to the various embodiments disclosed herein.

In case that the instruction is executed by the processor, the processor may directly perform a function corresponding to the instruction or other components may perform the function corresponding to the instruction under control of the processor. The instruction may include codes provided or executed by a compiler or an interpreter.

While the disclosure has been illustrated and described with reference to various example embodiments, it will be understood that the various example embodiments are intended to be illustrative, not limiting. It will be understood by those skilled in the art that the disclosure is not limited to the specific embodiments, may be variously modified without departing from the gist of the disclosure including the appended claims and their equivalents, and such modifications should not be individually understood from technical concepts or prospects of the disclosure. It will also be understood that any of the embodiment(s) described herein may be used in conjunction with any other embodiment(s) described herein.

What is claimed is:

1. An electronic device comprising:
a voice reception unit comprising circuitry;
memory storing an artificial intelligence model configured to acquire a voice signal of a user from an audio signal and information on characteristics of a plurality of users; and
at least one processor, comprising processing circuitry, individually and/or collectively, configured to:
based on an audio signal being received through the voice reception unit, obtain a first audio signal by inputting information on a characteristic of a first user set as a target speaker among the plurality of users and the received audio signal to the artificial intelligence model; and
based on voice recognition based on the first audio signal failing, identify a similarity between information on a characteristic of a second audio signal excluding the first audio signal among the received audio signals and information on characteristics of remaining users excluding the first user among the plurality of users, and change the target speaker to a second user among the plurality of users.

2. The device as claimed in claim 1, wherein at least one processor, individually and/or collectively, is configured to:
based on voice recognition based on the first audio signal failing, acquiring the second audio signal including a voice signal of another user other than the first user, present in the received audio signal, based on the first audio signal and information on a characteristic of the first user.

3. The device as claimed in claim 1, wherein at least one processor, individually and/or collectively, is configured to:
based on a similarity between information on a characteristic of the second signal and information on a characteristic of the second user having a greatest value among the identified similarities, change the target speaker to the second user.

4. The device as claimed in claim 3, wherein the information on characteristics of a plurality of users is embedded in vectors of the plurality of users; and
wherein at least one processor, individually and/or collectively, is configured to identify a similarity between a speaker embedding vector of the second audio signal and a speaker embedding vector of the remaining users.

5. The device as claimed in claim 3, wherein the similarity between information on a characteristic of the second signal and information on a characteristic of the second user has a greatest value among the identified similarities based on the voice signal included in the received audio signal being a voice signal of the second user.

6. The device as claimed in claim 1, wherein at least one processor, individually and/or collectively, is configured to maintain the first user as the target speaker based on the identified similarities being identical.

7. The device as claimed in claim 6, wherein the identified similarities are identical based on the received audio signal not including a voice signal of any user among the plurality of users or the received audio signal not including any voice signal.

8. The device as claimed in claim 1, wherein at least one processor, individually and/or collectively, is configured to:
based on the target speaker being changed to the second user, obtain a voice signal of the second user from the received audio signal by inputting information on a characteristic of the second user and the received audio signal to the artificial intelligence model, and perform voice recognition based on the voice signal of the second user.

9. A method of updating a target speaker of an electronic device, the method comprising;
based on an audio signal being received, acquiring a first audio signal by inputting information on a characteristic of a first user set as a target speaker among a plurality of users and the received audio signal to an artificial intelligence model configured to acquire a voice signal of a user from an audio signal;
based on voice recognition based on the first audio signal failing, identifying a similarity between information on a characteristic of a second audio signal excluding the first audio signal among the received audio signals and information on characteristics of remaining users excluding the first user among the plurality of users; and
changing the target speaker to a second user among the plurality of users.

10. The method as claimed in claim 9, further comprising:
based on voice recognition based on the first audio signal failing, acquiring a voice signal of another user other than the first user, present in the received audio signal, based on the first audio signal and information on a characteristic of the first user.

11. The method as claimed in claim 9, wherein the changing comprises:
based on a similarity between information on a characteristic of the second signal and information on a characteristic of the second user having a greatest value among the identified similarities, changing the target speaker to the second user.

12. The method as claimed in claim 11, wherein the information on characteristics of a plurality of users is embedded in vectors of the plurality of users; and
wherein the identifying comprises identifying a similarity between a speaker embedding vector of the second audio signal and a speaker embedding vector of the remaining users.

13. The method as claimed in claim 11, wherein the similarity between information on a characteristic of the second signal and information on a characteristic of the second user has a greatest value among the identified similarities based on the voice signal included in the received audio signal being a voice signal of the second user.

14. The method as claimed in claim 9, further comprising:
maintaining the first user as the target speaker based on the identified similarities being identical.

15. The method as claimed in claim 14, wherein the identified similarities are identical based on the received audio signal not including a voice signal of any user among the plurality of users or the received audio signal not including any voice signal.

16. The method as claimed in claim 9, further comprising:
based on the target speaker being changed to the second user, obtaining a voice signal of the second user from the received audio signal by inputting information on a characteristic of the second user and the received audio signal to the artificial intelligence model, and performing voice recognition based on the voice signal of the second user.

17. A non-transitory computer readable recording medium storing computer instructions that cause an electronic device to perform an operation when executed by at least one processor of the electronic device, wherein the operation comprises; based on an audio signal being received, acquiring a first audio signal by inputting information on a characteristic of a first user set as a target speaker among a plurality of users and the received audio signal to an artificial intelligence model configured to acquire a voice signal of a user from an audio signal;
based on voice recognition based on the first audio signal failing, identifying a similarity between information on a characteristic of a second audio signal excluding the first audio signal among the received audio signals and information on characteristics of remaining users excluding the first user among the plurality of users; and
changing the target speaker to a second user among the plurality of users.

18. The medium as claimed in claim 17, further comprising:
based on voice recognition based on the first audio signal failing, acquiring a voice signal of another user other than the first user, present in the received audio signal, based on the first audio signal and information on a characteristic of the first user.

19. The medium as claimed in claim 17, wherein the changing comprises:
based on a similarity between information on a characteristic of the second signal and information on a characteristic of the second user having a greatest value among the identified similarities, changing the target speaker to the second user.

20. The medium as claimed in claim 19, wherein the information on characteristics of a plurality of users is embedded in vectors of the plurality of users; and
wherein the identifying comprises identifying a similarity between a speaker embedding vector of the second audio signal and a speaker embedding vector of the remaining users.
